(19) United States
(12) Patent Application Publication
(10) Pub. No.: US 2025/0142366 A1
(43) Pub. Date: May 1, 2025

(54) METHODS AND APPARATUS FOR MONITORING PERFORMANCE OF TWO-SIDED AI/ML MODELS IN A WIRELESS COMMUNICATION SYSTEM

(71) Applicants: Centre of Excellence in Wireless Technology, Tamil Nadu (IN); INDIAN INSTITUTE OF TECHNOLOGY MADRAS (IIT Madras), Tamil Nadu (IN)

(72) Inventors: Advith Arun, Tamil Nadu (IN); Shiv Sankar, Tamil Nadu (IN); Jeniston Deviraj Klutto Milleth, Tamil Nadu (IN); Bhaskar Ramamurthi, Tamil Nadu (IN)

(21) Appl. No.: 18/934,128

(22) Filed: Oct. 31, 2024

(30) Foreign Application Priority Data
Nov. 1, 2023 (IN) 202341074465

(51) Int. Cl. H04W 24/02; G06F 16/174; H04L 41/16

(52) U.S. Cl. CPC H04W 24/02; G06F 16/1744; H04L 41/16

(57) ABSTRACT

The present disclosure provides methods and apparatuses for monitoring performance of two-sided AI/ML models in a wireless communication system. The method comprises of computing at least one first basis vector of an input data matrix and obtaining a compressed data matrix, by passing the data matrix through an AI/ML encoder model. The method further comprises of transmitting, the compressed data matrix in one of a control or a data channel.

### CROSS-REFERENCE TO RELATED APPLICATIONS

This application claims the benefit of Indian Patent Application number 202341074465, filed 1 Nov. 2023 the disclosure of which is incorporated herein by reference in its entirety.

### FIELD OF THE INVENTION

The present disclosure generally relates to wireless communication and particularly to methods and apparatuses for monitoring performance of two-sided AI/ML models in a wireless communication system.

### BACKGROUND

The future wireless technologies are expected to be artificial intelligence (AI)/machine learning (ML) centric across all layers from physical layer to the application layer. AI/ML may be used to assist an existing block in the transmit-receive chain.

In these cases, there a need for an AI/ML model, which is a data-driven algorithm that applies techniques to generate required outputs based on a set of inputs. The process by which the model tries to learn this relationship is referred to as model training. To ensure that the model also performs well on unseen input conditions, a sub-process of model training termed as model validation is used to evaluate the quality of the trained AI/ML model. The process of using a trained AI/ML model to obtain output for a set of inputs is termed as model inference.

When an AI/ML model is deployed in a wireless entity for a period of time, there is a possibility that the accuracy of the model may degrade over time. Therefore, it is significantly important to monitor the performance of the deployed AI/ML model to take corrective measures like updating the model. In this present disclosure, a novel method for monitoring performance of AI/ML models is proposed.

### OBJECT OF THE INVENTION

It is another object of the present disclosure to measure the performance degradation of the AI/ML model to update the model.

It is yet another object of the present disclosure to provide method and apparatus for monitoring performance of two-sided AI/ML models deployed in an entity.

### SUMMARY

The present disclosure provides techniques to monitoring performance of an artificial intelligence/machine learning (AI/ML) model at both first and second entities in a wireless communication system.

In one embodiment, a method for monitoring performance of a two-sided artificial intelligence/machine learning (AI/ML) model in a wireless communication system is disclosed. The method comprises of computing at least one first basis vector of an input data matrix and obtaining a compressed data matrix, by passing the data matrix through an AI/ML encoder model. Then, the compressed data matrix is transmitted in one of a control or a data channel.

In one aspect, the method of computing the at least one first basis vector of the input data matrix further comprises obtaining an at least encoded basis vector using at least one basis vector of the data matrix and obtaining an at least one quantized basis vector by quantizing the at least one encoded basis vector. Then, the at least one quantized basis vector may be transmitted in one of a control or a data channel.

In another embodiment, a method for monitoring performance of a two-sided artificial intelligence/machine learning (AI/ML) model in a wireless communication system. The method comprises of computing at least one first basis vector of an input data matrix and obtaining a compressed data matrix, by passing the data matrix through an AI/ML encoder model. The method further comprises receiving at least second basis vector, wherein the at least one second basis vector is obtained by encoding the decompressed data matrix, and obtaining a performance metric (ρ), by computing an error between the at least one first basis vector and the at least one second basis vector.

In another embodiment, a method for monitoring performance of a two-sided artificial intelligence/machine learning (AI/ML) model in a wireless communication system is disclosed. The method comprises of receiving a compressed data matrix in one of a control or a data channel. The method further comprises of obtaining a decompressed data matrix, by passing the compressed data matrix through the AI/ML decoder model and at least one first basis vector may be computed using the decompressed data matrix. Then, the at least one first basis vector may be transmitted.

In another embodiment, a method for monitoring performance of a two-sided artificial intelligence/machine learning (AI/ML) model in a wireless communication system is disclosed. The method comprises of receiving a compressed data matrix in one of a control or a data channel and receiving, at least one quantized basis vector of the data matrix. The method further comprises of obtaining a decompressed data matrix, by passing the compressed data matrix through the AI/ML decoder model. At least one first basis vector may be computed using the decompressed data matrix. At least one second basis vector may be reconstructed using the at least one quantized basis vector of the data matrix and a performance metric (ρ), may be obtained by computing an error between the at least one first basis vector and the at least one second basis vector.

In one aspect, wherein the error is computed as one of: a difference between the least one first basis vector and the at least one second basis vector; a dot product of least one first basis vector and the at least one second basis vector; and a correlation between the least one first basis vector and the at least one second basis vector.

In one aspect, the at least one of the first basis vector and the at least one of the second basis vector is obtained by applying a standard basis function.

In one aspect, the standard basis function is one of Fourier transform based or eigen valued decomposition based.

In one aspect, encoding and quantizing of at least one basis vector of the input is based on sparsity of the input data.

In one aspect, the data matrix comprises at least one of the information related to location, channel impulse response (CIR), channel state information (CSI) matrix.

In one aspect, the performance metric (ρ) is at least one of the indicators for AI/ML model retraining or AI/ML model switching in the lifecycle of an AI/ML model.

In one aspect, the AI/ML model is a two-sided autoencoder based model.

In one aspect, the two-sided model consists of an encoder model and a decoder model, wherein the encoder model obtains relevant feature from the data matrix and maps it into a compressed representation and the decoder model reconstructs the original data matrix from the compressed representation.

In one aspect, the encoder model is at a wireless entity and the decoder model is at a different wireless entity and the final output of the two-sided model is obtained at the location of the decoder model.

In one aspect, the periodicity of monitoring the performance of a two-sided AI/ML model in the wireless communication system in at least one of every inference operation, and several coherence units of the channel.

In another embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to compute at least one first basis vector of an input data matrix and obtain a compressed data matrix, by passing the data matrix through an AI/ML encoder model. The processor further configured to transmit the compressed data matrix in one of a control or a data channel.

In one aspect, the processor configured to compute the at least one first basis vector of the input data matrix by obtaining an at least encoded basis vector using the at least one basis vector of the data matrix, obtaining an at least one quantized basis vector by quantizing the at least one encoded basis vector, and transmitting, the at least one quantized basis vector in one of a control or a data channel.

In another embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to compute at least one first basis vector of an input data matrix, obtain a compressed data matrix, by passing the data matrix through an AI/ML encoder model. The processor further configured to receive at least second basis vector; wherein the at least one second basis vector is obtained by encoding the decompressed data matrix. Then, a performance metric (ρ), may be obtained by computing the error between the at least one first basis vector and the at least one second basis vector.

In another embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to receive a compressed data matrix in one of a control or a data channel and receive, at least one quantized basis vector of the data matrix. The processor further configured to obtain a decompressed data matrix, by passing the compressed data matrix through the AI/ML decoder model and compute at least one first basis vector using the decompressed data matrix. Then, the at least one first basis vector may be transmitted.

In another embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to receive a compressed data matrix in one of a control or a data channel and receive, at least one quantized basis vector of the data matrix. The processor further configured to obtain a decompressed data matrix, by passing the compressed data matrix through the AI/ML decoder model and compute at least one first basis vector using the decompressed data matrix. Then, at least one second basis vector may be reconstructed using the at least one quantized basis vector of the data matrix, and a performance metric (ρ), may be obtained by computing the error between the at least one first basis vector and the at least one second basis vector.

Other aspects and advantages of the present invention will become apparent from the following description, taken in conjunction with the accompanying drawings, illustrating by way of example the principles of the invention.

### BRIEF DESCRIPTION OF THE DRAWINGS

FIG. 1 illustrates a schematic diagram of one-sided AI/ML model deployed in a first entity, in accordance with an embodiment of the present disclosure;

FIG. 2 illustrates a schematic diagram of one-sided AI/ML model deployed in a second entity, in accordance with an embodiment of the present disclosure;

FIG. 3 illustrates a schematic diagram of two-sided AI/ML model deployed in both the first and second entities, in accordance with an embodiment of the present disclosure;

FIG. 4 illustrates a schematic diagram of monitoring of two-sided AI/ML model at a second entity (NW side), with feedback of transformed input (B) as an encoded and quantised representation (C), in accordance with an embodiment of the present disclosure;

FIG. 5 illustrates a schematic diagram of monitoring of two-sided AI/ML model at a first entity (UE side), with feedback of transformed output (B) as an encoded and quantised representation (C) bar in accordance with an embodiment of the present disclosure;

FIG. 6 illustrates a schematic diagram of monitoring of two-sided AI/ML model at a second entity (NW side), with feedback of transformed output (B) bar as an encoded and quantised representation (C) bar in accordance with an embodiment of the present disclosure;

FIG. 7 illustrates a schematic diagram of monitoring of two-sided AI/ML model at a first entity (UE side), with feedback of transformed input in accordance with an embodiment of the present disclosure;

FIG. 8 illustrates a flow diagram of a method for monitoring performance of an artificial intelligence/machine learning (AI/ML) model in a wireless communication system, in accordance with an embodiment of the present disclosure;

FIG. 9 illustrates a flow diagram of a method for monitoring performance of an artificial intelligence/machine learning (AI/ML) model in a wireless communication system, in accordance with an embodiment of the present disclosure;

FIG. 10 illustrates a flow diagram of a method for monitoring performance of an artificial intelligence/machine learning (AI/ML) model in a wireless communication system, in accordance with an embodiment of the present disclosure;

FIG. 11 illustrates a flow diagram of a method for monitoring performance of an artificial intelligence/machine learning (AI/ML) model in a wireless communication system, in accordance with an embodiment of the present disclosure;

FIG. 12 illustrates a schematic drawing of an apparatus for monitoring performance of an artificial intelligence/machine learning (AI/ML) model in accordance with an embodiment of the present disclosure;

FIG. 13 illustrates a schematic drawing of an apparatus for monitoring performance of an artificial intelligence/machine learning (AI/ML) model in accordance with an embodiment of the present disclosure.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “in another embodiment”, “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment). The expression “at least one of A, B and C” or “at least one of the following: A, B and C” means “only A, or only B, or only C, or any combination of A, B and C.”

The word “example” or “exemplary” is used herein to mean “serving as an example, instance, or illustration.” Any implementation described herein as “exemplary” is not necessarily to be construed as preferred or advantageous over other implementations.

Embodiments herein are described within the context of 5G NR radio technology. It is to be appreciated that the problems and solutions mentioned herein apply equally to wireless access networks and UEs that use different access technologies and standards. NR is used as an example technology where embodiments are appropriate, and include NR in the description is therefore very valuable for understanding the problem and finding solutions to it. In particular, embodiments are equally applicable to 3GPP LTE, or 3GPP LTE plus NR integration.

In the present disclosure an AI/ML model deployed in an entity is discussed, wherein AI/ML is a data-driven algorithm that applies techniques to generate required outputs based on a set of inputs. The process by which the model tries to learn this relationship may be referred to as model training. Further, to ensure that the model performs well on unseen input conditions, a sub-process of model training termed as model validation may be used to evaluate the quality of the trained AI/ML model. In addition, the process of using a trained AI/ML model to obtain output for a set of inputs may be termed as model inference.

When an AI/ML model is deployed in a wireless entity for a period of time, there may be a possibility that the accuracy of the model may degrade over time. Therefore, it may be significantly important to monitor the performance of the deployed AI/ML model to take corrective measures like updating the model. In the present disclosure, a novel method for monitoring performance of two-sided AI/ML models is proposed.

In an embodiment, the wireless systems may have several types of AI/ML models depending upon the applications, the specific AI/ML model architectures may be used. Some of the AI/ML model architectures are (1) Deep Neural Networks, which contains input and output nodes with multiple intermediate neuron layers in the network. (2) Convolutional Neural Networks performs convolution operation using various filters to extract features from the input. (3) Recurrent Neural Networks is more suitable for processing data with memory of previous samples. e.g.: time series forecasting.

In an embodiment, the AI/ML models deployed in an entity within a communication network may be categorized depending on functionality and ease of implementation such as (i) User equipment (UE) sided models (ii) Network (NW) sided models. The wireless communication network may be 5G or NR network or some other wireless network, such as LTE network. The wireless communication network may include a number of base stations (BSs) to support communications for a number of user equipment (UEs) and other network entities. The BS may also be referred to as a new radio (NR) BS, an evolved Node B (eNB), a Node B, a gNB, a 5G node B, an access point (AP), a transmit and receive point (TRP), a radio head, and/or the like. The UEs in the wireless communication network may also be referred to as a mobile station, a subscriber unit, a station, an access terminal, mobile device, user terminal, user device, a terminal, and/or the like. Each UE may be stationary or mobile. A UE may be a cellular phone, a wireless communication device, a personal digital assistant (PDA), a wireless modem, a handheld device, a tablet computer, a laptop computer, a cordless phone, a wireless local loop (WLL) station, or the like. In the present disclosure, the UE may be referred to a first entity and base station may be referred to a second entity and the working of the first and the second entity that includes an AI/ML model may be detailed infra. The term UE or the first entity and the term NW or the second entity may be used interchangeably throughout this disclosure.

In an embodiment, the UE may communicate with the BS via the downlink and uplink. The downlink refers to the communications link from the BS to the UE, and the uplink refers to the communications link from the UE to the BS. The communication link may be transmitted from the UE (the first entity) to the BS (the second entity) through physical uplink control channel (PUCCH) and communication link may be received by the UE (the first entity) from the BS (the second entity) through physical downlink control channel (PDCCH).

In an embodiment, the present invention discloses that AI/ML models may be deployed at either one side (UE or NW) or at both sides (UE and NW). In other words, the AI/ML models may be deployed at either one side (such as at the first entity (UE) or at the second entity (NW)) or at both sides such as at the first (UE) and the second entities (NW).

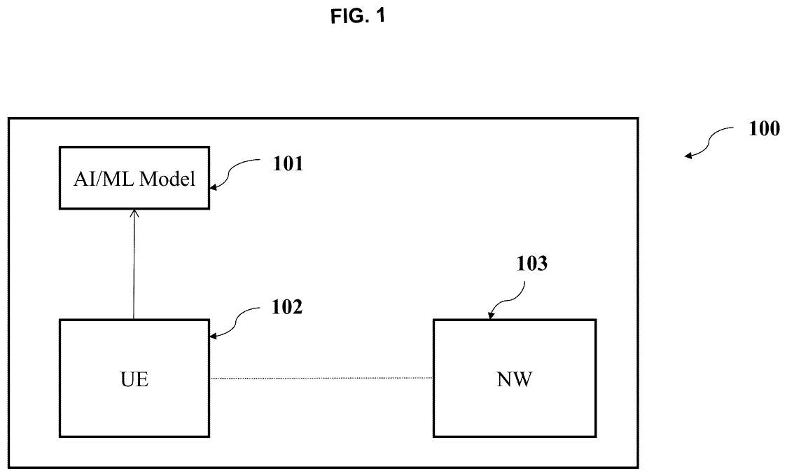

FIG. 1 illustrates a schematic diagram of one-sided AI/ML model deployed in a first entity, in accordance with an embodiment of the present disclosure. FIG. 1 shows the AI/ML model deployed at one side that is at the first entity. In case of one-sided model, the model may be trained at a single location i.e., the model is trained at the first entity and the result may be used for further processing.

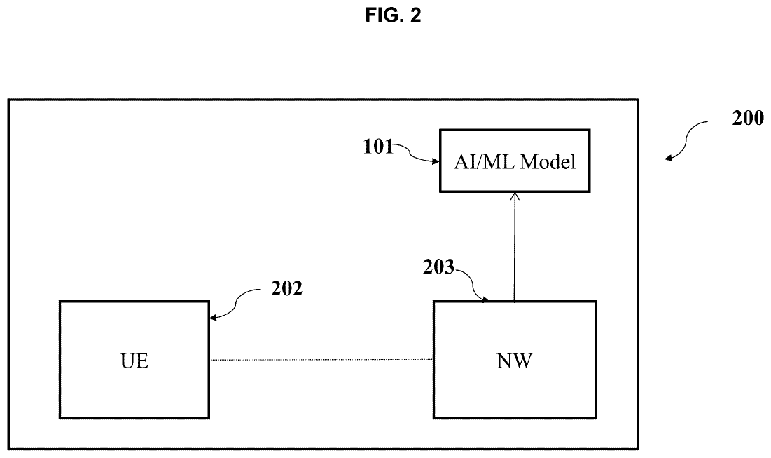

Similarly, FIG. 2 illustrates a schematic diagram of one-sided AI/ML model deployed in a second entity, in accordance with an embodiment of the present disclosure. The AI/ML model deployed only at the second entity, the model may be trained at the second entity and the result may be used for further processing.

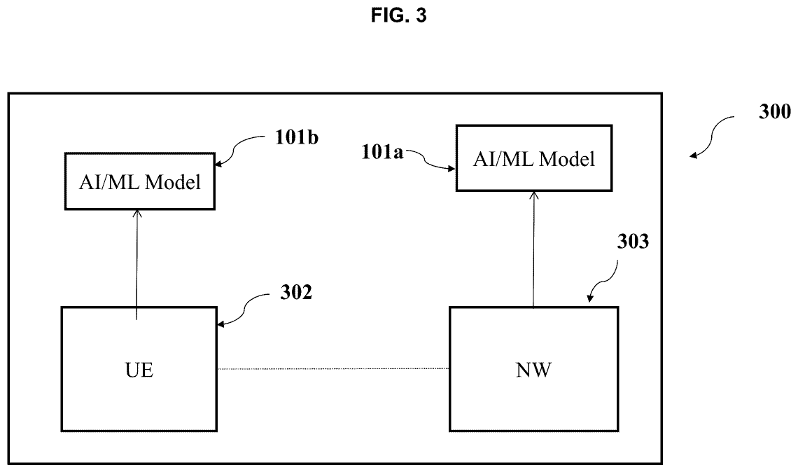

FIG. 3 is a schematic diagram of two-sided AI/ML model deployed in both the first and second entities, in accordance with an embodiment of the present disclosure. In case of a two-sided model, a pair of AI/ML models located in both at the first entity (UE side) and at the second entity (NW side) may be trained jointly for inference. For example, the first entity (UE) may use the AI/ML model as part of an encoding process for encoding (and/or compressing) channel state information (CSI) for its transmission to the second entity (NW), and the second entity may use an AI/ML model as part of a corresponding decoding (and/or decompressing) process for decoding the CSI received from the first entity. The channel state information (CSI) includes the channel properties of a communication link.

In an embodiment, the present invention discloses that in real time scenarios, the performance of a deployed AI/ML model may degrade over time due to various reasons, such as change in statistics of the input data (e.g.: CSI), Imperfect model selection and switching, and lack of proper validation dataset. Therefore, it may be important to monitor the performance of the model deployed in the wireless entity during the life-cycle management phase. The present invention proposes methods to measure model performance of deployed two-sided AI/ML model.

In an embodiment, the present invention discloses that in a two-sided model, where part of model (e.g.: encoder) may be at one location (e.g.: UE or NW) and another part of model (e.g. decoder) may be at another location (e.g.: NW or UE), the output of the model (e.g. decoder) may be usually obtained at a different side than the model input. The performance of the deployed model may be monitored to encounter performance degradation due to changes in statistics of the input data.

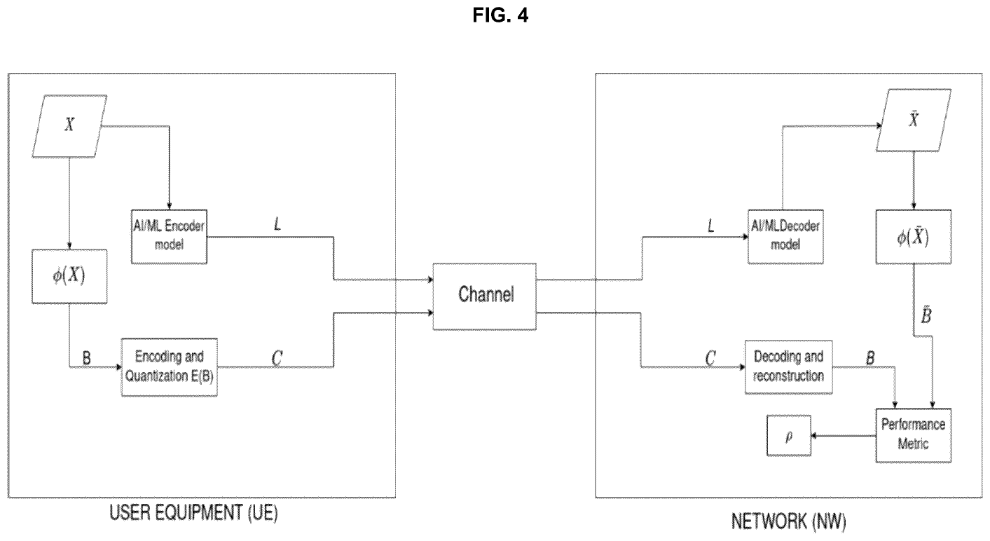

FIG. 4 illustrates a schematic diagram of monitoring of two-sided model at a second entity (NW side), with feedback of transformed input (B) as an encoded and quantised representation (C) in accordance with an embodiment of the present disclosure. FIG. 4 also shows the methodology to compute performance metrics of the deployed AI/ML model as detailed in the following. In an exemplary embodiment, the AI/ML model includes an encoder model and decoder model, which may be deployed at both the first and second entities. Alternatively, the AI/ML model may be a two-sided autoencoder based model. The encoder model obtains relevant feature from the input data matrix and maps it into a compressed representation and the decoder model reconstructs the original data matrix from the compressed representation. Further, the AI/ML encoder model may be deployed at a wireless entity and the AI/ML decoder model may be deployed at a different wireless entity and the final output of the two-sided AI/ML model is obtained at the location of the AI/ML decoder model.

In one side (e.g. a first entity or UE side), an input data matrix represented as (X) is fed into the AI/ML encoder model to obtain the compressed data represented as (L). The compressed data (L) may be transmitted from one side (e.g. first entity or UE side) to the other side (e.g. second entity or NW side) through a control channel or through data channel.

Further, the input data matrix may be projected on some standard basis (e.g., Discrete Fourier Transform (DFT) basis) or basis vector (e.g., eigen vector). The standard basis function operation may be applied on the input data matrix to compute the first basis vector, the operation may be represented as φ(X̅), and the input data matrix may be represented as (X). The standard basis function may be any one of Fourier transform based or eigen valued decomposition based. In a non-limiting example, the input data matrix includes at least one of the information related to location, channel impulse response (CIR), channel state information (CSI) matrix. In certain other embodiment, the data matrix may also include additional information for monitoring performance of a two-sided artificial intelligence/machine learning (AI/ML) model in a wireless communication system. The input data matrix is projected on standard basis by the above said operation to obtain a set of first basis vectors represented as (B). The at least one basis vector (B) may be further encoded and quantized E (B) to generate payload bit represented as parameter (C). The payload bit (C) is generated based on sparsity present in the data. Then, the generated payload bit (C) may be sent from the first entity (UE side) to the second entity (NW side) through a control channel or data channel.

On the other side (e.g. second entity or NW side) the AI/ML decoder model decompresses the received compressed data matrix (L) to obtain output data which is represented as (X̅). Further, the decoded data (X̅) may be passed through the same (φ) operation i.e., φ(X̅) to obtain at least one second basis vector (B). Also, the payload bit (C) received from the first entity (UE side) may be decoded and reconstructed to obtain B) vector.

In an embodiment, similarity metrics such as normalized mean square error (NMSE) method or (GCS) method may be applied to compute a measure of error between a set of vectors (̅B̅)̅ obtained from standard basis function φ(X̅) and the decoded and reconstructed vectors (B) received from the first entity at a second entity (NW side). The computed similarity metric may be used as a performance indicator metric/performance metric (ρ). Further, this performance metric (ρ) metric may be used as at least one of indicators to take decisions for fallback to legacy non-AI/ML based methods, AI/ML model retraining or AI/ML model switching, etc., in the lifecycle of an AI/ML model in a wireless system. In other words, the performance metric may be obtained by computing an error between the at least one first basis vector and the at least one second basis vector, wherein the at least one of the at least first basis vector and at least one second basis vector may be obtained by applying a standard basis function φ(X̅). The error may be computed as one of a difference between the least one first basis vector and the at least one second basis vector, a dot product of least one first basis vector and the at least one second basis vector; and a correlation between the least one first basis vector and the at least one second basis vector.

In an embodiment, the present invention discloses that based on the deployment and model monitoring requirements of two-sided models, there can be four possible combinations as shown in the Table 1. Table 1 shows the feedback required for all possible cases of deployed two-sided AI/ML model. In some cases, the transformed input may be fed back and in others, the transformed output may be fed back to the monitoring location as explained in FIGS. 4, 5, 6 and 7. The periodicity of monitoring the performance of a two-sided AI/ML model in the wireless communication system may be performed in at least one of: every inference operation or several coherence units of the channel.

TABLE 1
Feedback parameter for various configurations of two-sided model

Feedback

| | Model |
|---|---|
| Location of AI/ML model | Monitoring |

| UE side | NW side | location | Parameter |
|---|---|---|---|
| Encoder | Decoder | NW | C |
| | | UE | C̅ |
| Decoder | Encoder | NW | C̅ |
| | | UE | C |

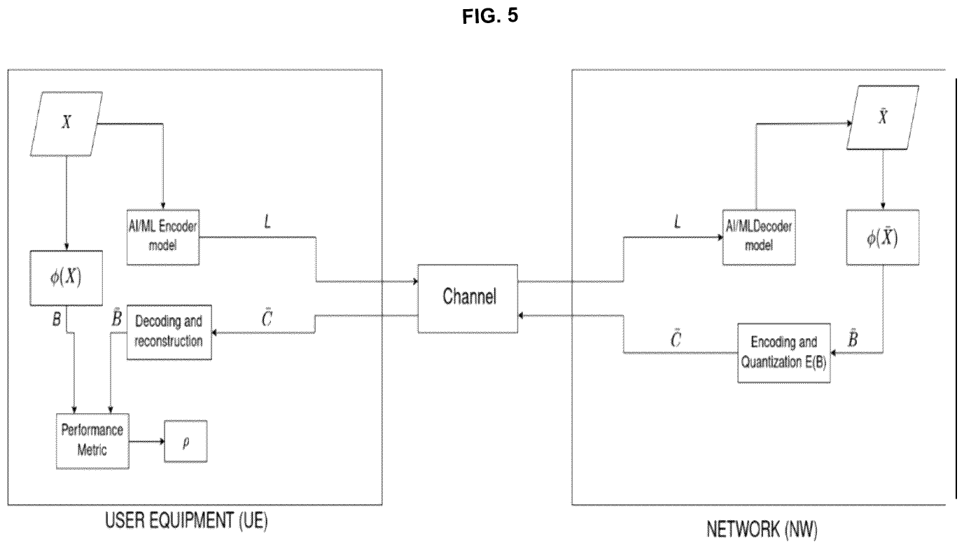

FIG. 5 illustrates a schematic diagram of monitoring of two-sided model at a first entity (UE side), with the feedback of transformed output (B) bar as an encoded and quantized representation in accordance with an embodiment of the present disclosure. In an exemplary embodiment, the AI/ML model includes an AI/ML encoder model and an AI/ML decoder model deployed at both the first and second entities. An input data matrix represented as (X) may be fed into the AI/ML encoder model, to obtain the compressed data (L). The compressed data represented as (L) may be transmitted from the first entity (UE side) to the second entity (NW side) through PUCCH or PUSCH.

The AI/ML decoder model which is deployed in the second entity, receives the compressed data matrix (L) and decompresses the compressed data to obtain output data (X̅). Further, the decoded output data X̅ is projected on standard basis vector operation i.e., φ(X̅) to obtain at least one second basis vector (B̅) (e.g., eigen vector). The basis vector (B̅) may be further encoded and quantized E (B) to generate payload bit represented as parameter (C̅). The transformed output may be transmitted from the second entity to the first entity through PDCCH or PDSCH.

The first entity receives the payload bit (C̅) transmitted from the second entity. The received payload bit (C̅) may be decoded and reconstructed to obtain at least one second basis vector (B̅). Further, the input data (X) in the first entity is projected on the same basis function φ, i.e. φ(X) to obtain at least one first basis vector (B).

The similarity metrics may be applied to compute the performance metric (ρ) between decoded and reconstructed basis vector (B̅) and computed vector (B) received from passing through the operation at the first entity (UE side). The performance degradation of the AI/ML model may be obtained from the performance metric (ρ).

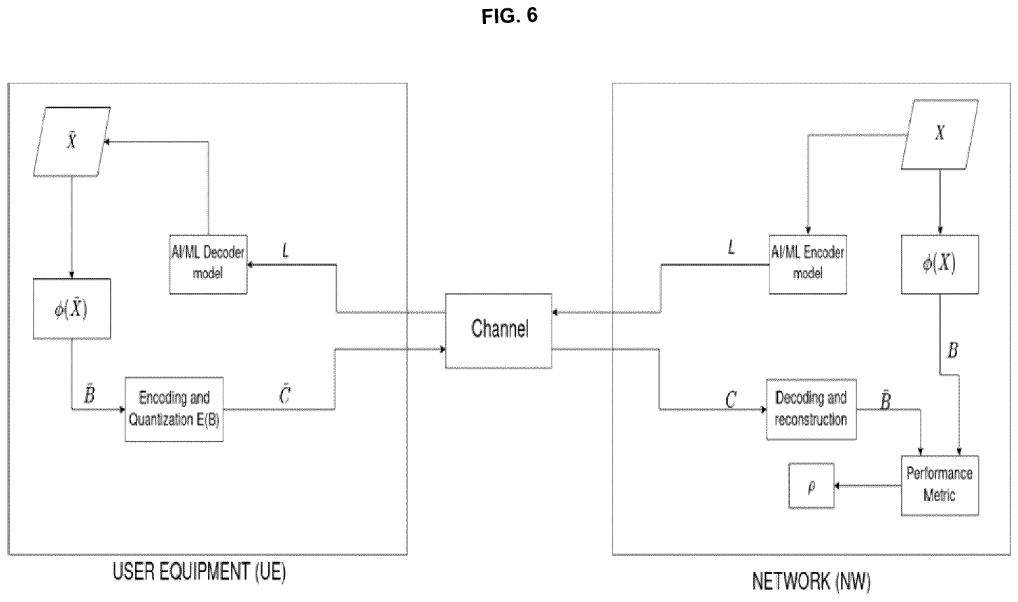

FIG. 6 illustrates a schematic diagram of monitoring of two-sided model at a second entity (NW side), with feedback of transformed output (B̅), as an encoded and quantized representation (C̅) in accordance with an embodiment of the present disclosure. In an exemplary embodiment, the AI/ML decoder model and AI/ML encoder model may be deployed at both the first and second entities. An input data matrix represented as (X) may be fed into the AI/ML encoder model to obtain the compressed data matrix (L) at the second entity. The compressed data matrix (L) may be transmitted from the second entity to the first entity through PDCCH or PDSCH.

The AI/ML decoder model deployed at the first entity decodes the received compressed data matrix (L) to obtain the output data (X̅). The decoded data matrix (X̅) is projected on a standard basis function φ, i.e. φ(X̅) to obtain at least one second basis vector (B̅). The basis vector (B̅) may be further encoded and quantized to generate payload bit represented as (C̅). Then, the generated payload bit (C̅) may be transmitted from the first entity to the second entity through at least one of PUCCH or PUSCH.

The second entity receives the transformed output in the form of payload bit (C̅). The received payload bit (C̅) may be decoded and reconstructed to obtain to obtain basis vector (B̅). Further, the input data at the second entity is projected on the same basis function q, i.e. φ(X̅), to obtain the at least one first basis vector (B) at the second entity. Finally, the similarity metrics may be applied to compute the performance metric (ρ), as a measure of error between at least one second basis vector (B̅) and the computed at least one first vector (B), to identify the performance degradation of the AI/ML model that is obtained from the performance metric (ρ).

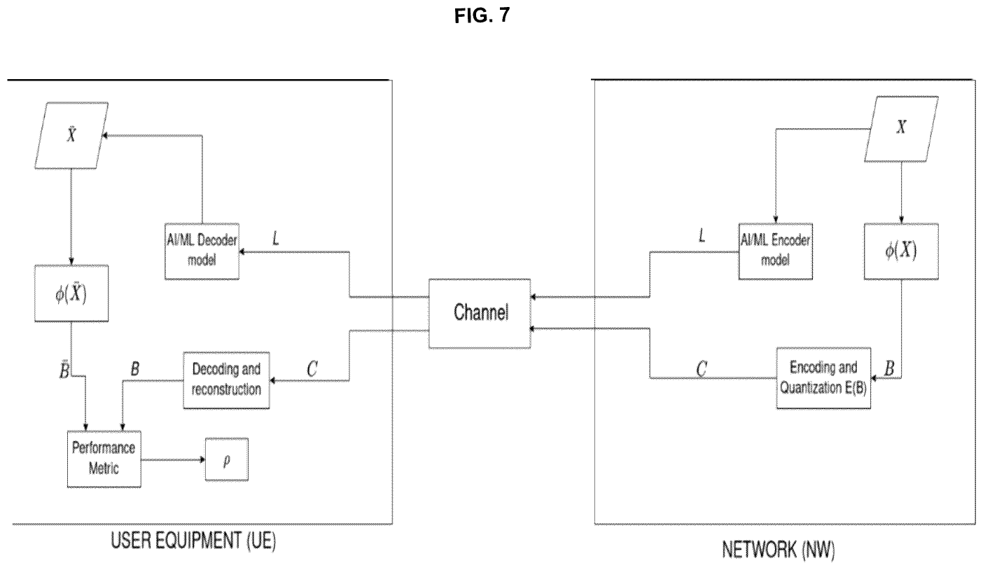

FIG. 7 illustrates a schematic diagram of monitoring of two-sided model at a first entity (UE side), with feedback of transformed input (B) as an encoded and quantized representation (C) in accordance with an embodiment of the present disclosure. In an exemplary embodiment, the AI/ML encoder model AI/ML decoder model deployed at both the first and second entities. An input data matrix represented as (X) may be fed into the AI/ML encoder model, to obtain the compressed data matrix (L). The compressed data represented as (L) may be transmitted from the first entity (UE side) to the second entity (NW side) through PDCCH or PDSCH. The data matrix is projected on standard basis vector operation i.e., φ(X) to obtain at least one first basis vector (B) at the second entity. The at least one first basis vector (B) may be further encoded and quantized E (B) to generate the payload bit (C) it may be transmitted from the second entity to the first entity through PDCCH and PDSCH.

The AI/ML decoder model in the first entity, receives the compressed data matrix (L) and decompresses the compressed data matrix to obtain output data (X̅). Further, the decompressed data matrix (X̅) is projected on the same standard basis operation φ(X̅) to obtain at least one second basis vector (B̅) (e.g., eigen vector). Further, the first entity receives the transformed input in the form of payload bit (C) transmitted from the second entity. The decoder decodes and reconstructs the received payload (C) to obtain the at least one first basis vector (B).

Finally, the similarity metrics may be applied to compute the performance metric (ρ), as a measure of error+between the at least one received and reconstructed first basis vector and the computed second basis vector at the first entity (UE side) to identify the performance degradation of the AI/ML model that is obtained from the performance metric (ρ).

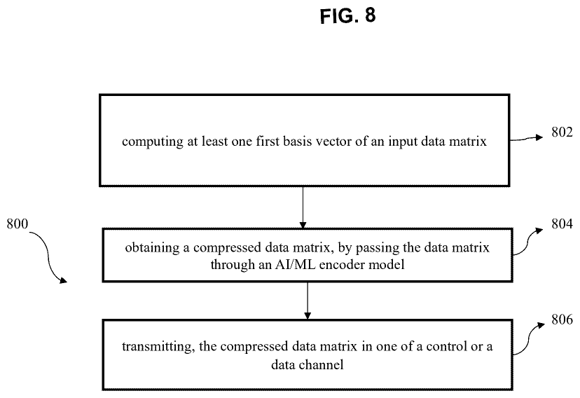

FIG. 8 illustrates a flow diagram of a method (800) for monitoring performance of an artificial intelligence/machine learning (AI/ML) model in a wireless communication system, in accordance with an embodiment of the present invention. In an embodiment, the method comprises of computing at least one first basis vector of an input data matrix, at step 802. At step 804, a compressed data matrix, may be obtained by passing the data matrix through an AI/ML encoder model. At step 806, transmitting, the compressed data matrix in one of a control or a data channel. The method further comprises of obtaining an at least encoded basis vector using at least one basis vector of the data matrix and obtaining an at least one quantized basis vector by quantizing the at least one encoded basis vector. Then, transmitting, the at least one quantized basis vector in one of a control or a data channel.

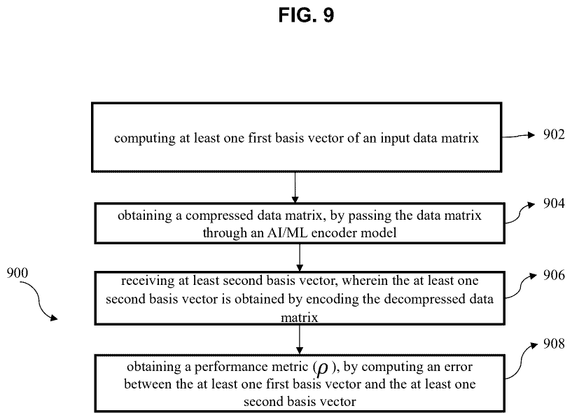

FIG. 9 illustrates a flow diagram of a method (900) for monitoring performance of an artificial intelligence/machine learning (AI/ML) model in a wireless communication system, in accordance with an embodiment of the present disclosure. In an embodiment, the method comprises of computing at least one first basis vector of an input data matrix, at step 902 and obtaining a compressed data matrix, by passing the data matrix through an AI/ML encoder model, at step 904. The method further comprises of receiving at least second basis vector, wherein the at least one second basis vector is obtained by encoding the decompressed data matrix, at step 906 and obtaining a performance metric (ρ), by computing an error between the at least one first basis vector and the at least one second basis vector, at step 908.

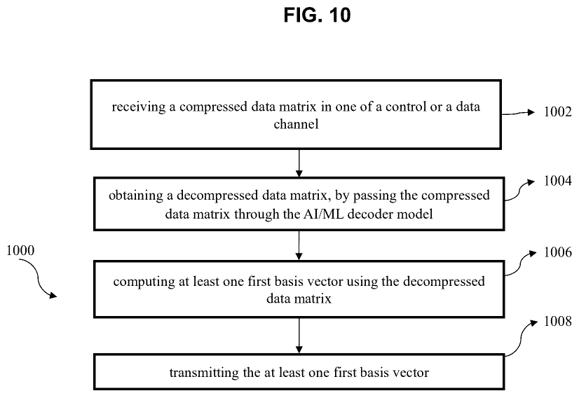

FIG. 10 illustrates a flow diagram of a method (1000) for monitoring performance of an artificial intelligence/machine learning (AI/ML) model in a wireless communication system, in accordance with an embodiment of the present disclosure. In one embodiment, the method comprises of receiving a compressed data matrix in one of a control or a data channel, at step 1002. The method further comprises of obtaining a decompressed data matrix, by passing the compressed data matrix through the AI/ML decoder model, at step 1006 and computing at least one first basis vector using the decompressed data matrix, at step 1008. At step 1010, the at least one first basis vector may be transmitted.

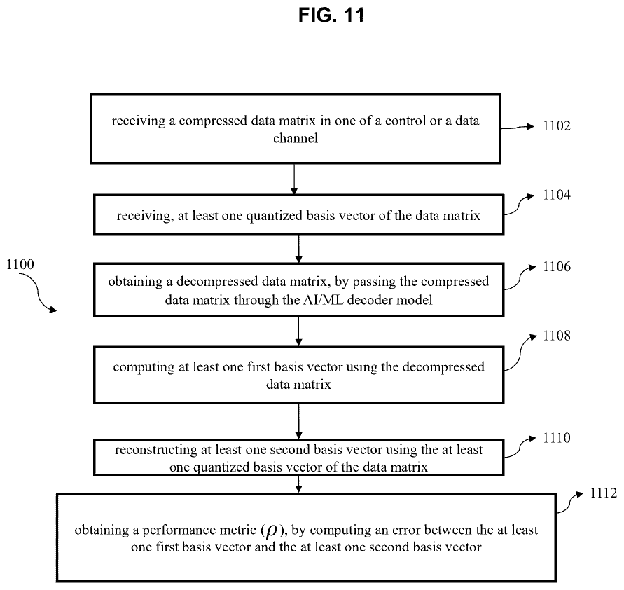

FIG. 11 illustrates a flow diagram of a method (1100) for monitoring performance of an artificial intelligence/machine learning (AI/ML) model in a wireless communication system, in accordance with an embodiment of the present disclosure. In one embodiment, the method comprises of receiving a compressed data matrix in one of a control or a data channel, at step 1102 and receiving, at least one quantized basis vector of the data matrix, at step 1104. The method further comprises of obtaining a decompressed data matrix, by passing the compressed data matrix through the AI/ML decoder model, at step 1106, and computing at least one first basis vector using the decompressed data matrix, at step 1108. Then, at step 1110 reconstructing at least one second basis vector using the at least one quantized basis vector of the data matrix; and at step 1112, obtaining a performance metric (ρ), by computing an error between the at least one first basis vector and the at least one second basis vector.

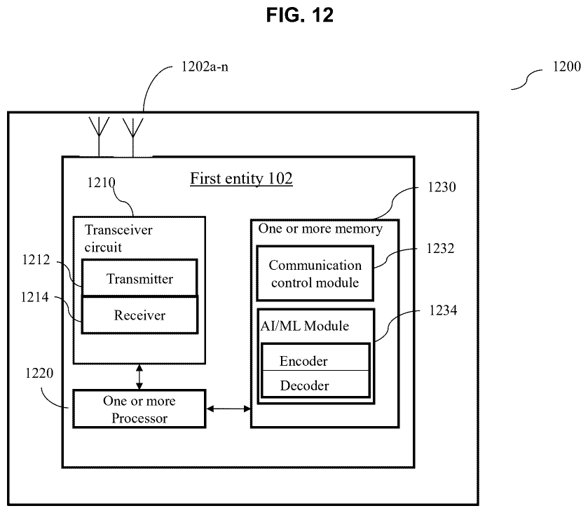

FIG. 12 illustrates a schematic drawing of an apparatus for monitoring performance of an artificial intelligence/machine learning (AI/ML) model at a first entity (102) in accordance with an embodiment of the present disclosure. The apparatus (1200) for monitoring performance of an AI/ML model includes a first entity or UE (102). The first entity may comprise constructional features like one or more processor (1220), transceiver circuit (1210), one or more memory (1230), etc., The processor (1220) may be associated with the memory (1230) and coupled to the transceiver circuit (1210). The transceiver circuit (1210) may include transmitter (1212) and receiver (1214) to transmit and receive signals from a base station via one or more antennas (1202 a-n). Additionally, the first entity (102) may also include all usual functional features of a conventional UE for its operation like user interface such as touch screen, keypad, microphone, speaker, etc., by allowing direct control and user interaction with a user, and this may be provided by any one or combination of hardware or software, or firmware, appropriate. One or more memory (1230) includes a communication control module (1232) and an AI/ML module (1234). The communication control module (1232) may be operable to control the communication between the UE and other serving base stations or other communication devices. The AI/ML module (1234) further includes an encoder and a decoder for encoding and decoding the data in accordance with an embodiment of the present disclosure.

In an embodiment, the apparatus for monitoring an artificial intelligence/machine learning (AI/ML) model at a first entity in a wireless communication system. The apparatus comprising one or more processor (1220), one or more memory (1230) in electronic communication with the one or more processor, and instructions stored in the one or more memory and executable by the one or more processor configured to perform method steps of 902 to 912 as shown on FIG. 9. The first entity includes the transceiver circuit (1210) configured to transmit a compressed data matrix (X) in the form of latent space representation (L) through a physical downlink control channel (PDCCH) and receive an encoded and quantized basis vector (B̅) of output data (x̅) in the form of a payload (C̅) from a second entity. The first entity further includes processor configured to decode the payload (C̅) to reconstruct the basis vector (B̅), and compute a basis vector (B) from the input data (X). Then, the processor (1220) of the first entity configured to compute a performance metric (ρ) by comparing the reconstructed basis vector (B̅) and the computed basis vector (B), wherein performance metric (ρ) is an indicator for measuring performance degradation of the AI/ML model.

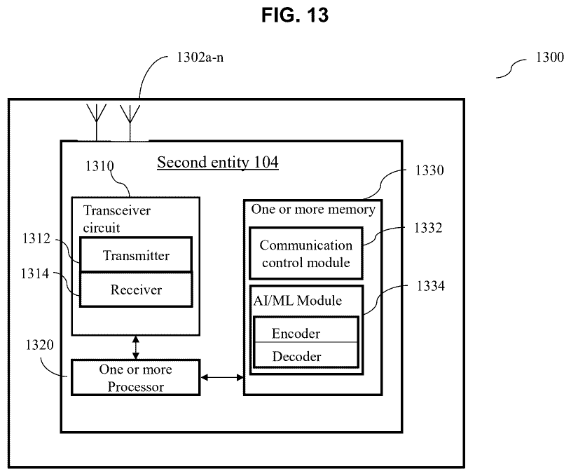

FIG. 13 illustrates a schematic drawing of an apparatus for monitoring performance of an artificial intelligence/machine learning (AI/ML) model at a second entity (104) in accordance with an embodiment of the present disclosure. The apparatus (1300) for monitoring performance of an AI/ML model includes a second entity (104). The second entity may comprise constructional features like one or more processor (1320), transceiver circuit (1310), one or more memory (1330), etc. The processor may be associated with the memory (1330) and coupled to the transceiver circuit (1310). The transceiver circuit (1310) may include transmitter (1312) and receiver (1314) to transmit and receive signals from the communication devices (102) via one or more antennas (1302 a-n). One or more memory (1330) includes a communication control module (1332) and an AI/ML module (1134). The communication control module (1332) may be operable to control the communication between the base stations and the UEs and other network entities. The AI/ML module (1334) further includes an encoder and a decoder for encoding and decoding the data in accordance with an embodiment of the present disclosure.

In an embodiment, the apparatus for monitoring an artificial intelligence/machine learning (AI/ML) model at a second entity in a wireless communication system. The apparatus comprising one or more processor (1320), one or more memory (1330) in electronic communication with the one or more processor, and instructions stored in the one or more memory and executable by the one or more processor configured to perform method steps of 802 to 812 as shown on FIG. 8. The second entity includes the transceiver circuit (1310) configured to receive a compressed data matrix (X) in the form of latent space representation (L) through a physical uplink control channel (PUCCH) and decode the latent space representation (L) to obtain output data (x̅) by reconstructing the original input. The second entity further includes processor configured to compute a basis vector (B̅) from the decoded output data (x̅). The second entity receives an encoded and quantized basis vector (B) of the input data in the form of a payload (C) through the PUCCH from the first entity. Then, the processor (1120) of the second entity configured to decode the payload (C) to reconstruct basis vector (B) and compute a performance metric (ρ) by comparing the reconstructed basis vector (B) and the computed basis vector (B̅), wherein performance metric (ρ) is an indicator for measuring performance degradation of the AI/ML model.

In one embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to compute at least one first basis vector of an input data matrix, and obtain a compressed data matrix, by passing the data matrix through an AI/ML encoder model. The processor further configured to transmit, the compressed data matrix in one of a control or a data channel.

In another embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to compute at least one first basis vector of an input data matrix, obtain a compressed data matrix, by passing the data matrix through an AI/ML encoder model. The processor further configured to receive at least second basis vector; wherein the at least one second basis vector is obtained by encoding the decompressed data matrix. Then, a performance metric (ρ), may be obtained by computing the error between the at least one first basis vector and the at least one second basis vector.

In another embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to receive a compressed data matrix in one of a control or a data channel. The processor further configured to obtain a decompressed data matrix, by passing the compressed data matrix through the AI/ML decoder model and compute at least one first basis vector using the decompressed data matrix. Then, the at least one first basis vector may be transmitted.

In another embodiment, an apparatus for monitoring artificial intelligence/machine learning (AI/ML) model in a wireless communication system is disclosed. The apparatus comprising one or more processor, one or more memory in electronic communication with the one or more processor, and instructions stored in the one or more memory and executable by the one or more processor configured to receive a compressed data matrix in one of a control or a data channel and receive, at least one quantized basis vector of the data matrix. The processor further configured to obtain a decompressed data matrix, by passing the compressed data matrix through the AI/ML decoder model and compute at least one first basis vector using the decompressed data matrix. Then, at least one second basis vector may be reconstructed using the at least one quantized basis vector of the data matrix, and a performance metric (ρ), may be obtained by computing the error between the at least one first basis vector and the at least one second basis vector.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. A method for monitoring performance of a two-sided artificial intelligence/machine learning (AI/ML) model in a wireless communication system, the method comprising:
computing at least one first basis vector of an input data matrix;
obtaining a compressed data matrix, by passing the data matrix through an AI/ML encoder model; and
transmitting, the compressed data matrix in one of a control or a data channel.

2. The method as claimed in claim 1, wherein computing the at least one first basis vector of the input data matrix further comprises;
obtaining an at least encoded basis vector using at least one basis vector of the data matrix;
obtaining an at least one quantized basis vector by quantizing the at least one encoded basis vector; and
transmitting, the at least one quantized basis vector in one of a control or a data channel.

3. A method for monitoring performance of a two-sided artificial intelligence/machine learning (AI/ML) model in a wireless communication system, the method comprising:
computing at least one first basis vector of an input data matrix;
obtaining a compressed data matrix, by passing the data matrix through an AI/ML encoder model;
receiving at least one second basis vector, wherein the at least one second basis vector is obtained by encoding a decompressed data matrix; and
obtaining a performance metric (ρ), by computing an error between the at least one first basis vector and the at least one second basis vector.

4. A method for monitoring performance of a two-sided artificial intelligence/machine learning (AI/ML) model in a wireless communication system, the method comprising:
receiving a compressed data matrix in one of a control or a data channel;
obtaining a decompressed data matrix, by passing the compressed data matrix through the AI/ML decoder model;
computing at least one first basis vector using the decompressed data matrix; and
transmitting the at least one first basis vector.

5. A method for monitoring performance of a two-sided artificial intelligence/machine learning (AI/ML) model in a wireless communication system, the method comprising:
receiving a compressed data matrix in one of a control or a data channel;
receiving, at least one quantized basis vector of the data matrix;
obtaining a decompressed data matrix, by passing the compressed data matrix through the AI/ML decoder model;
computing at least one first basis vector using the decompressed data matrix;
reconstructing at least one second basis vector using the at least one quantized basis vector of the data matrix; and
obtaining a performance metric (ρ), by computing an error between the at least one first basis vector and the at least one second basis vector.

6. The method as claimed in claim 1, wherein an error is computed as one of:
a difference between the least one first basis vector and the at least one second basis vector;
a dot product of least one first basis vector and the at least one second basis vector; and
a correlation between the least one first basis vector and the at least one second basis vector.

7. The method as claimed in claim 1, wherein the at least one of the at least one first basis vector and the at least one second basis vector is obtained by applying a standard basis function.

8. The method as claimed in claim 1, wherein a standard basis function is one of Fourier transform based or eigen valued decomposition based.

9. The method as claimed in claim 1, wherein encoding and quantizing of at least one basis vector of the input is based on sparsity of the input data.

10. The method as claimed in claim 1, wherein the data matrix comprises at least one of information related to location, channel impulse response (CIR), channel state information (CSI) matrix.

11. The method as claimed in claim 1, wherein the performance metric (ρ) is at least one of indicators for fallback to legacy non-AI/ML based methods, AI/ML model retraining or AI/ML model switching in a lifecycle of an AI/ML model.

12. The method as claimed in claim 1, wherein the AI/ML model is a two-sided autoencoder based model.

13. The method as claimed in claim 12,
wherein the two-sided model consists of an encoder model and a decoder model;
wherein the encoder model obtains relevant feature from the data matrix and maps it into a compressed representation and the decoder model reconstructs the original data matrix from the compressed representation.

14. The method as claimed in claim 13,
wherein the encoder model is at a wireless entity and the decoder model is at a different wireless entity and a final output of the two-sided model is obtained at a location of the AI/ML decoder model.

15. The method as claimed in claim 1, wherein a periodicity of monitoring the performance of a two-sided AI/ML model in the wireless communication system at least one of,
every inference operation,
several coherence units of the channel.

16. An apparatus for monitoring artificial intelligence/machine learning (AI/ML) model in a wireless communication system, the apparatus comprising:
one or more processor;
one or more memory in electronic communication with the one or more processor, and instructions stored in the one or more memory and executable by the one or more processor configured to:
compute at least one first basis vector of an input data matrix;
obtain a compressed data matrix, by passing the data matrix through an AI/ML encoder model; and
transmit, the compressed data matrix in one of a control or a data channel.

17. The apparatus as claimed in claim 16, wherein the one or more processor configured to compute the at least one first basis vector of the input data matrix further configured to:
obtain an at least encoded basis vector using the at least one basis vector of the data matrix;
obtain an at least one quantized basis vector by quantizing the at least one encoded basis vector; and
transmit, the at least one quantized basis vector in one of a control or a data channel.

18. An apparatus for monitoring artificial intelligence/machine learning (AI/ML) model in a wireless communication system, the apparatus comprising:
one or more processor;
one or more memory in electronic communication with the one or more processor, and instructions stored in the one or more memory and executable by the one or more processor configured to:
compute at least one first basis vector of an input data matrix;
obtain a compressed data matrix, by passing the data matrix through an AI/ML encoder model;
receive at least second basis vector; wherein the at least one second basis vector is obtained by encoding a decompressed data matrix; and
obtain a performance metric (ρ), by computing the error between the at least one first basis vector and the at least one second basis vector.

19. An apparatus for monitoring artificial intelligence/machine learning (AI/ML) model in a wireless communication system, the apparatus comprising:
one or more processor;
one or more memory in electronic communication with the one or more processor, and instructions stored in the one or more memory and executable by the one or more processor configured to:
receive a compressed data matrix in one of a control or a data channel;
receive, at least one quantized basis vector of the data matrix;
obtain a decompressed data matrix, by passing the compressed data matrix through an AI/ML decoder model;
compute at least one first basis vector using the decompressed data matrix; and
transmit the at least one first basis vector.

20. An apparatus for monitoring artificial intelligence/machine learning (AI/ML) model in a wireless communication system, the apparatus comprising:
one or more processor;
one or more memory in electronic communication with the one or more processor, and instructions stored in the one or more memory and executable by the one or more processor configured to:
receive a compressed data matrix in one of a control or a data channel;
receive, at least one quantized basis vector of the data matrix;
obtain a decompressed data matrix, by passing the compressed data matrix through an AI/ML decoder model;
compute at least one first basis vector using the decompressed data matrix;
reconstruct at least one second basis vector using the at least one quantized basis vector of the data matrix; and
obtain a performance metric (ρ), by computing the error between the at least one first basis vector and the at least one second basis vector.
